(19) United States
(12) Patent Application Publication
(10) Pub. No.: US 2026/0205504 A1
(43) Pub. Date: Jul. 16, 2026

(54) VOICE OVER IP CORE TELEPHONY FUNCTIONALITY SOFTWARE DEVELOPMENT KIT

(71) Applicant: CONVO VOMMUNICATIONS LLC, Austin, TX (US)

(72) Inventor: Felipe Ignacio Mederios Bustos, Curauma (CL)

(21) Appl. No.: 19/447,249

(22) Filed: Jan. 13, 2026

Related U.S. Application Data
(60) Provisional application No. 63/745,230, filed on Jan. 14, 2025.

(51) Int. Cl. H04L 65/1096; G06F 9/54; H04L 65/1069; H04L 65/1073; H04M 7/00

(52) U.S. Cl. CPC H04L 65/1096; G06F 9/541; G06F 9/547; H04L 65/1069; H04L 65/1073; H04M 7/0084

(57) ABSTRACT

A software development kit (SDK) is configured to be integrated with a client application executing on a user device. The SDK includes an application programming interface (API) layer configured to receive requests for communication services from the client application, a registrar configured to manage registration state associated with the client application, an orchestrator configured to coordinate communication operations within the SDK, a signaling module configured to manage session initiation, termination, and call state signaling for audio and video communication sessions, a media module configured to manage real-time media streams; and a communication provider adapter interface defining a standardized interface for accessing communication services.

### RELATED APPLICATION

This non-provisional patent application claims the benefit of U.S. Patent Application No. 63/745,230 filed on Jan. 14, 2025, the entirety of which is incorporated herein by reference.

### FIELD

The present disclosure relates generally to video relay services, and in particular to a Voice over Internet Protocol (VoIP) core telephony functionality Software Development Kit (SDK) for implementing services related to Video Relay Service (VRS). The present disclosure may also find application for on-demand video remote interpreting (VRI) services.

### BACKGROUND

Voice over Internet Protocol (VoIP) is a technology that enables the transmission of voice communications and multimedia sessions over the Internet or other IP-based networks. Unlike traditional telephone systems that rely on circuit-switched networks, VoIP converts analog voice signals into digital data packets that can be transmitted over IP networks. This allows users to make voice calls, video calls, and other multimedia communications using their internet connection rather than traditional telephone lines. VoIP offers cost-effective communication solutions, flexibility, and a wide range of features such as call forwarding, voicemail, and conferencing, making it a popular choice for businesses and individuals alike.

The concept of transmitting voice over data networks emerged in the late 20th century, with initial experiments conducted in the 1970s and 1980s. In 1973, Network Voice Protocol (NVP) was developed, followed by the development of Internet Protocol (IP) in the late 1970s and early 1980s. The commercialization of VoIP began in the mid-1990s as internet bandwidth and technology improved. Companies like VocalTec Communications introduced the first commercial VoIP application in 1995, allowing users to make calls over the internet using a microphone and speakers connected to their computer. Throughout the late 1990s and early 2000s, VoIP technology continued to evolve rapidly. Advancements in compression algorithms, network infrastructure, and Quality of Service (QoS) improvements led to better voice quality and reliability. By the mid-2000s, VoIP had gained mainstream acceptance, particularly among businesses seeking cost-effective communication solutions. Skype, founded in 2003, became one of the most popular VoIP services, offering free voice and video calls between users. The rise of smartphones and mobile broadband further accelerated the adoption of VoIP. Mobile VoIP applications like WhatsApp, Viber, and FaceTime allowed users to make voice and video calls over Wi-Fi or cellular data networks, bypassing traditional voice networks. VoIP technology continues to evolve, with the emergence of new standards like Session Initiation Protocol (SIP), WebRTC, and cloud-based VoIP services. Today, VoIP is an integral part of modern communication infrastructure, powering everything from personal calls to enterprise-grade communication systems.

### BRIEF DESCRIPTION OF THE DRAWINGS

FIG. 1 is a simplified diagram of the tech stack for the Software Development Kit (SDK) according to the teachings of the present disclosure;

FIG. 2 is a simplified block diagram of the internal and external component interactions for the Software Development Kit (SDK) according to the teachings of the present disclosure;

FIG. 3 is a simplified data flow diagram for the Software Development Kit (SDK) according to the teachings of the present disclosure;

FIGS. 4 and 5 show the message flow diagrams of the registration and re-registration processes according to the teachings of the present disclosure;

FIGS. 6 and 7 show the message flow diagrams for active and lazy incoming call flows where the app selects the target phone number from the SIP INVITE message according to the teachings of the present disclosure;

FIG. 8 is a process flow diagram showing interactions between the Client applications, User Management System (UMS), database (DB), and Notifications API (NotifsAPI) to handle notifications missed and abandoned calls, including mechanisms for updating and resetting the notification badge count, ensuring users are promptly informed about call activity, according to the teachings of the present disclosure;

FIG. 9 is a process flow diagram of notification handling while offline according to the teachings of the present disclosure;

FIG. 10 is a process flow diagram of handling Apple Push Notification Service (APNs) according to the teachings of the present disclosure;

FIG. 11 is a system context diagram of the call stats module and its interactions with other system components and external entities according to the teachings of the present disclosure;

FIG. 12 is a diagram showing the statistics data being collected from a WebRTC session according to the teachings of the present disclosure;

FIG. 13 is a process flow diagram of the Call Stats Module designed to collect, log, and report statistics from both Network and WebRTC modules during an active call according to the teachings of the present disclosure;

FIG. 14 is an architecture diagram of the Call Stats Module according to the teachings of the present disclosure;

FIG. 15 shows a diagram that illustrates the API contract between User Agent Server (UAS) and Video Interpreter (VI) App according to the teachings of the present disclosure; and

FIG. 16 is a simplified block diagram of an exemplary embodiment of the VRS system architecture according to the teachings of the present disclosure.

### DETAILED DESCRIPTION

Session Initiation Protocol (SIP) is a communication protocol used in VoIP (Voice over Internet Protocol) and multimedia sessions such as voice and video calls over IP networks. SIP is the foundation for initiating, modifying, and terminating real-time communication sessions over IP networks between computing/mobile devices. SIP provides a framework for signaling and controlling communication sessions, enabling devices and applications to establish and manage connections over the internet. It facilitates features like call setup, call transfer, conference calling, and presence detection. SIP operates in a client-server framework, where SIP user agents (clients) initiate and receive requests to establish sessions, and SIP servers facilitate communication by routing and processing these requests. SIP messages are text-based and follow a request-response model similar to Hypertext Transfer Protocol (HTTP). There are 14 SIP requests, which include: INVITE: Establishes a session; ACK: Confirms INVITE request; BYE: Ends a session; CANCEL: Cancels establishing a session; REGISTER: Communicates user location; and OPTIONS: Communicates info about the calling/receiving SIP phones' capabilities.

The present disclosure describes a system and method for encapsulating complex VoIP operations such as WebRTC wrapping, SIP protocol handling, media handling, session negotiation, platform communication, error management, session logging, and incoming call management into a modular reusable Software Development Kit (SDK) containing tools, libraries, and APIs (Application Programming Interfaces) that may be used to quickly build, test, and deploy mobile applications for multiple mobile platforms (e.g., mobile telephones with various operating systems), in particular, for Video Relay Services (VRS). The objectives of creating the SDK described herein include:
Simplification of Application Development: The application layer is significantly simplified, as software developers can focus on building user interfaces and user experiences without being encumbered by the underlying technical complexities of telephony functionalities.
Enhanced Scalability and Flexibility: The SDK provides a consistent and robust foundation across different platforms, enabling seamless migration or expansion from mobile applications to web browsers and potentially to emerging platforms in the future. This cross-platform compatibility ensures that the core functionality of the VoIP application remains uniform and high-performing, regardless of the user interface.
Rapid Iteration and Innovation: With the core audio & video telephony capabilities abstracted into the SDK, our team can more quickly iterate on the application layer, testing new features and interfaces without risking or requiring changes to the underlying infrastructure. This agility accelerates innovation and the ability to respond to market demands or user feedback.
Quality Control and Reliability: Centralizing audio & video telephony functionalities within the VoIP SDK means that any updates, bug fixes, or enhancements to these core features can be managed in a controlled manner, ensuring high standards of quality and reliability across all application instances. This uniformity aids in maintaining a consistent user experience and simplifies troubleshooting and support.
Future-proofing the Application: As telephony technologies evolve, changes can be made within the SDK to adopt new standards, protocols, or optimizations without necessitating a complete overhaul of the application layers. This design philosophy ensures that the VoIP application remains at the cutting edge of technology with minimal disruption to end-users.

The core telephony functionalities for the VRS application built using the SDK described herein include multiple telephone number support, visual indicator badges for missed and abandoned calls, call stats module, and UAS (User Agent Server) WebSocket. These functionalities are described in more detail below.

The multiple telephone number support function allows a user to use more than one telephone number on their user account. This function includes these features: loop through all phone numbers returned in the login response, register each phone number with the SIP registrar, authenticate with the authorization token for different scenarios, and re-register to the SIP registrar for incoming calls to receive the SIP INVITE.

When a user creates a user account for the VoIP service, they may enter one or more telephone numbers to be used with this user account. When the user logs in with the proper authentication credentials (e.g., username and password), the VoIP app receives the login response containing the user's phone numbers and an authorization token. The VoIP app then automatically obtains and loops through all of the user's phone numbers and registers each of them with the SIP registrar. Similarly, the VoIP app also registers each of the user's telephone numbers associated with the account when the user brings the app from the background to the foreground on the mobile device screen. If the user's device receives a notification alerting the user of a new phone number ready to use, the VoIP app authenticates the user with the authorization token returned in the prior login step, and the VoIP app again loops through all of the phone numbers, including the new phone number, and registers each with the SIP registrar. When the VoIP app detects an incoming call, the app identifies the target or called phone number for the call, and re-registers with the SIP registrar using the target phone number to receive the SIP INVITE message.

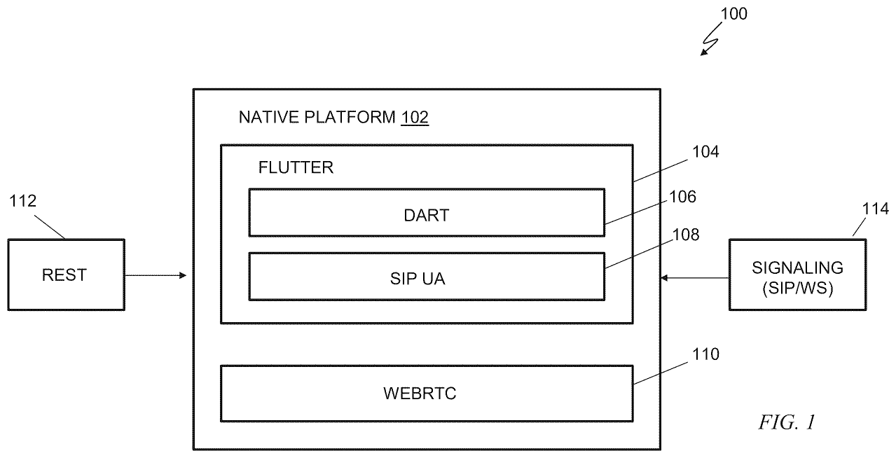

FIG. 1 illustrates an example high-level tech stack of the Software Development Kit (SDK) 100 according to one or more embodiments. As shown, the SDK 100 may be implemented using a native platform 102. In particular, an exemplary embodiment of the SDK is a Flutter/Dart-based SDK built primarily to be a cross platform media and SIP handling SDK. FIG. 1 conceptually depicts the interaction between the native application layer and underlying communication protocols, illustrating that the application framework abstracts protocol-specific complexity while enabling real-time voice, video, and signaling capabilities. This configuration allows the platform to support cross-platform native applications while maintaining compatibility with industry-standard communication infrastructures. The tech stack includes the following components:
Native Platform 102: The SDK is built to run on the native operating system (OS) of a mobile device, whether it be Android, iOS, or another OS to be developed in the future. The native platform 102 is configured to interface with one or more communication and signaling technologies, including Session Initiation Protocol (SIP) User Agent (UA) 108, Web Real-Time Communication (WebRTC) 110 for real-time audio and video media exchange, and REST-based signaling mechanisms 112. In some embodiments, signaling may be performed using SIP over WebSocket (SIP/WS) or other persistent signaling transports 114.
Flutter 104: Within the native platform, Flutter is used as the framework for building the user interface of the SDK. Flutter is an open-source User Interface (UI) software development kit created by Google. Flutter can be used to develop cross platform applications from a single codebase for the web, Fuchsia, Android, iOS, Linux, macOS, and Windows. Flutter's control of its rendering pipeline simplifies multi-platform support as identical UI code can be used for all target platforms.
Dart 106: Dart is an open-source, client-optimized programming language developed by Google for building fast applications on any platform, including mobile, web, desktop, and server-side. It serves as the foundation for the popular UI toolkit, Flutter, and is known for its productivity-enhancing features.
SIP UA (User Agent) 108: This sip_ua component within the Flutter framework handles SIP (Session Initiation Protocol) signaling. The SIP User Agent provides a complete SIP protocol stack for Dart, enabling cross-platform VoIP applications with audio/video calls, instant messaging, and call control features. It manages call setup, modification, and termination over an IP network, enabling VoIP call functionalities.
WebRTC (Web Real-Time Communication) 110: Below the Flutter framework, WebRTC is used for real-time communication capabilities. WebRTC is an open standard and set of APIs that enables direct, peer-to-peer audio, video, and data exchange in web browsers and mobile apps. WebRTC provides the necessary APIs and protocols for peer-to-peer audio, video, and data sharing directly within the SDK, without the need for plugins or external applications.
REST API (Representational State Transfer Application Programming Interface) 112: REST API is an architectural style for building web services that uses standard HTTP requests to access and manipulate data over the internet. It functions as a set of rules and guidelines that enable different software applications (clients and servers) to communicate with each other in a simple, scalable, and stateless manner. The SDK interacts with external services using RESTful web services by making HTTP requests to communicate with backend servers, fetch data, and perform various operations.
Signaling (SIP/WS) 114: the signaling component refers to the use of SIP (Session Initiation Protocol) over WebSockets (WS) transport protocol for signaling purposes. This component handles the negotiation and management of communication sessions, ensuring proper signaling for the WebRTC connections.

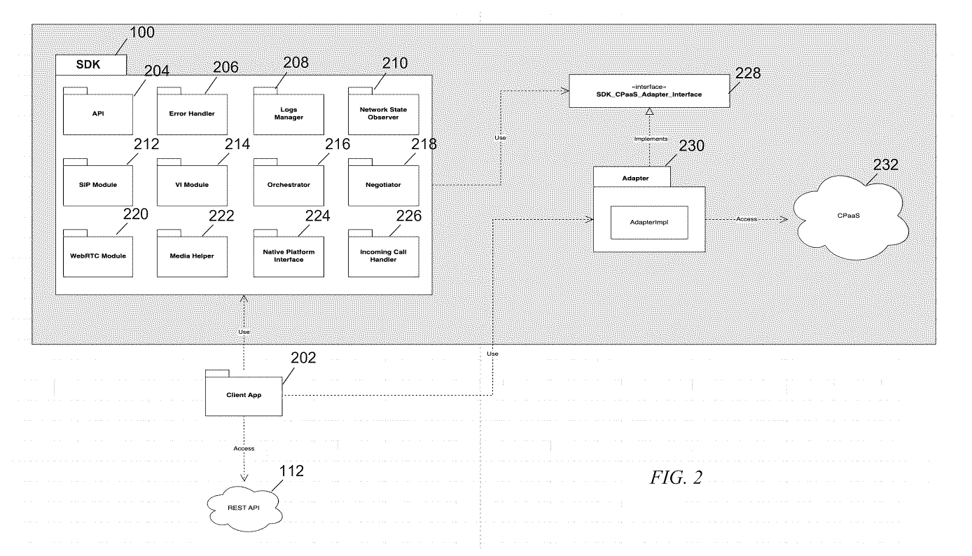

FIG. 2 is a simplified block diagram showing the internal components of the SDK 100 and their interaction with external components according to an exemplary embodiment of the SDK. FIG. 2 illustrates an SDK architecture configured to provide communication functionality to a client application 202. The SDK 100 exposes one or more public interfaces that are accessible by the client application 202, which may invoke SDK functionality without direct awareness of underlying communication protocols or service providers. In some embodiments, the client application communicates with external services, such as a REST API 112, through the SDK. As shown, the SDK 200 comprises a plurality of internal modules that collectively abstract communication services from the client application. These components cooperate to manage signaling, media transport, call control, device state monitoring, network monitoring, and platform-specific interactions.
API 204: This component provides an interface for other applications to interact with the SDK.
Error Handler 206: This component manages and handles errors within the SDK.
Logs Manager 208: This component is responsible for data and stats logging activities and events within the SDK.
Network State Observer 210: This component monitors and report on the network state and responds to changes.
SIP Module 212: This component handles SIP functionalities for establishing, modifying, and terminating audio and video communication sessions.
VI Module 214: This component handles signaling with the Video Interpreter API called User Agent Server (UAS) that is responsible for receiving and processing SIP requests.
Orchestrator 216: This component manages and coordinates different components and processes within the SDK.
Negotiator 218: This component manages the negotiation processes for a communication session, such as for establishing connections and audio/video sessions.
WebRTC Module 220: This component provides and enables WebRTC functionalities for real-time communication.
Media Helper 222: This component assists with media-related tasks such as audio and video handling.
Native Platform Interface 224: This component facilitates interaction between the SDK and the native platform it's running on.
Incoming Call Handler 226: This component manages and processes incoming calls.
SDK_CPaas_Adapter_Interface 228: This component is an interface used by the SDK 100 to interact with a CPaaS (Communications Platform as a Service) adapter 230.
Adapter 230: This component implements the SDK_CPaas_Adapter_Interface and contains the AdapterImpl. It provides concrete implementations for the CPaaS adapter functionalities.
CPaaS (Communications Platform as a Service) 232: The CPaaS adapter 230 accesses the CPaaS 232, indicating that the SDK 100 uses a CPaaS for communication services like voice, video, and messaging.

FIG. 2 illustrates an adapter architecture that enables the SDK 100 to interface with one or more third-party communication service providers. In particular, an SDK CPaaS adapter interface 230 defines a standardized contract that is implemented by one or more adapter implementations. Each adapter implementation translates SDK-level requests into provider-specific operations and communicates with a corresponding cloud-based CPaaS communication platform 232. This adapter-based design allows the SDK 100 to dynamically support multiple communication service providers without requiring changes to the client application 202 or core SDK logic. As a result, communication services may be easily substituted, upgraded, or extended by modifying adapter implementations while maintaining a consistent SDK interface.

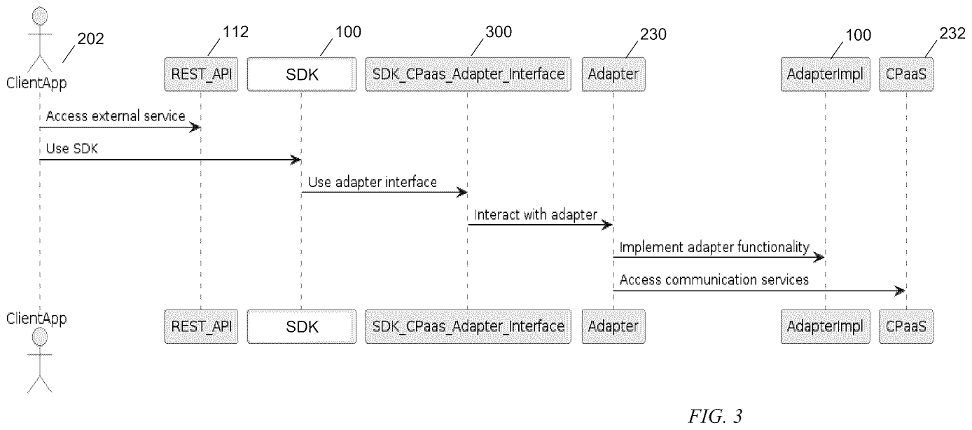

FIG. 3 is a simplified data flow diagram. FIG. 3 illustrates an example interaction sequence demonstrating how a client application accesses communication services through an SDK using an adapter-based architecture according to one or more embodiments. As shown, the client application 202 initiates access to a communication service by invoking functionality exposed by the SDK 100. The client app uses the SDK 100 for various functionalities from its components. The SDK 100 interacts with the CPaaS Adapter 232 by consuming the SDK_CPaas_Adapter_Interface 300. The adapter 230 implements the interface and accesses the CPaaS 232 for communication services.

In some embodiments, the client application may first interact with the REST API 112 to access external services or configuration data. The client application 202 then utilizes the SDK interface, which provides abstracted access to communication capabilities. The SDK 100 forwards service requests through the SDK CPaaS adapter interface 300, which defines a standardized set of operations independent of any specific communication service provider. The adapter interface delegates the request to a corresponding adapter, which implements provider-specific logic. The adapter interacts with an adapter implementation to translate the standardized SDK request into one or more operations compatible with a selected CPaaS 232. The CPaaS then provides the requested communication service, such as call setup, messaging, or media handling.

FIG. 3 further illustrates that responses and events generated by the CPaaS are propagated back through the adapter implementation, adapter, adapter interface, and SDK layers to the client application. This layered interaction enables the client application to consume communication services without direct dependency on CPaaS-specific APIs, protocols, or operational details. By isolating provider-specific functionality within adapter implementations, the architecture shown in FIG. 3 allows communication service providers to be replaced, added, or modified with minimal impact on the client application or core SDK logic.

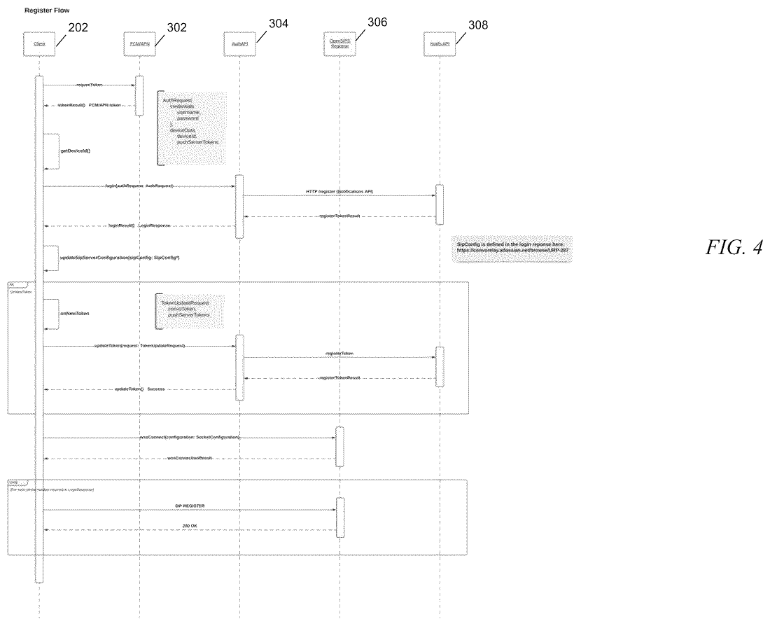

FIG. 4 illustrates an example registration and initialization sequence for establishing real-time communication readiness within a client application using the SDK according to one or more embodiments. The SDK coordinates interactions among multiple components, including an authentication service (AuthAPI) 304, a registration service (OpenSIPS Registrar) 306, and a communication service interface (NotifsAPI) 308. As shown, the flow begins when a Client App 202 initiates an authentication request with an Authentication Service (AuthAPI) 304. The Authentication Service 304 validates credentials associated with the Client App 202 and, upon successful authentication, returns authorization data to the Client App and/or SDK.

Following authentication, the Client App interacts with a Registration Service (OpenSIPS Registrar) 306 to initiate registration of the client device and application instance. The Registration Service coordinates with the SDK to register the client with a communication backend and to associate the client with required communication capabilities. During the registration process, the Client App obtains a push notification token from a platform-specific push notification service, such as Firebase Cloud Messaging (FCM) or Apple Push Notification service (APNs) 302. The SDK forwards the push notification token to the Registration Service, which stores the token and associates it with the registered client. The SDK then communicates with a CPaaS Adapter through an adapter interface to perform communication-specific registration with a CPaaS Platform. This may include registering signaling endpoints, initializing persistent signaling channels, and establishing readiness to receive incoming communication events.

Once registration with the CPaaS Platform is complete, the SDK transitions the Client App into a ready state. In this state, the Client App is capable of receiving incoming call notifications via FCM/APNs when operating in a background or inactive state. Upon receipt of a push notification indicating an incoming communication event, the SDK re-establishes signaling with the CPaaS Platform to complete call setup. This architecture enables reliable delivery of incoming communication events across application lifecycle states while abstracting authentication, registration, push notification handling, and CPaaS integration within the SDK.

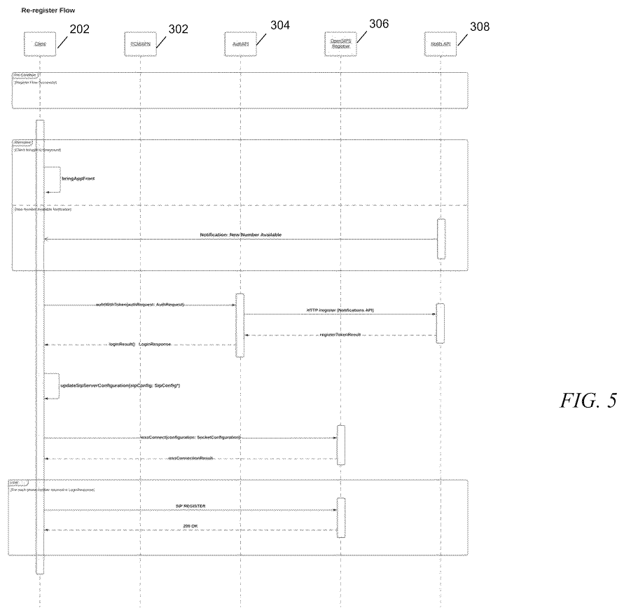

FIG. 5 illustrates an example re-register flow involving a Client, FCM/APN, AuthAPI, OpenSIPS Registrar, and NotifsAPI, according to one or more embodiments. As shown, the re-register flow is initiated when the Client determines that an existing registration must be refreshed or re-established. This may occur due to application restart, loss of connectivity, expiration of credentials, or another event affecting registration state. The Client first communicates with the AuthAPI to obtain or refresh authentication credentials. The AuthAPI validates the Client and returns authorization information that enables the Client to proceed with re-registration. Using the refreshed authorization information, the Client sends a re-registration request to the OpenSIPS Registrar. The OpenSIPS Registrar processes the request and updates registration state associated with the Client. As part of the re-register flow, the Client provides push notification information associated with FCM/APN. The OpenSIPS Registrar communicates with the NotifsAPI to associate the Client's registration with the provided push notification identifier. The NotifsAPI stores or updates notification routing information such that incoming communication events may be delivered to the Client via FCM/APN when the Client is inactive or unreachable through direct signaling. Upon successful completion of re-registration, the OpenSIPS Registrar confirms the updated registration state. The Client then resumes a registered state and is eligible to receive incoming communication events, either through direct signaling or via push notification delivery. If any step of the re-register flow fails, an error indication may be returned to the Client, and the Client may retry the re-register flow or take corrective action.

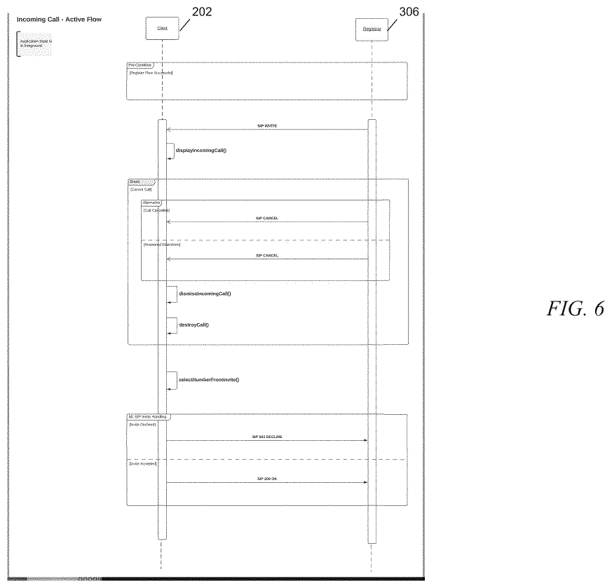

FIG. 6 illustrates an example incoming call handling flow when a client application is active, involving a Client and a Registrar, according to one or more embodiments. As shown, the flow begins when an incoming call is received while the Client application is in an active state and reachable through an established signaling connection. The Registrar receives signaling associated with the incoming call and determines that the Client is currently registered and available to receive the call. Upon confirming the Client's active registration status, the Registrar forwards incoming call information to the Client. The Client receives the incoming call indication and may present an incoming call interface to a user.

FIG. 6 further illustrates that the Client responds to the incoming call by transmitting a call response to the Registrar. If the user accepts the incoming call, the Client sends an acceptance message to the Registrar, and the Registrar updates call state to reflect call acceptance. If the user declines the call or does not respond, the Client notifies the Registrar accordingly, and the Registrar updates call state to reflect rejection or timeout.

Throughout the incoming call active flow, the Registrar manages call signaling and registration state, while the Client handles user interaction and call response. Because the Client is active, the flow proceeds without use of a push notification service.

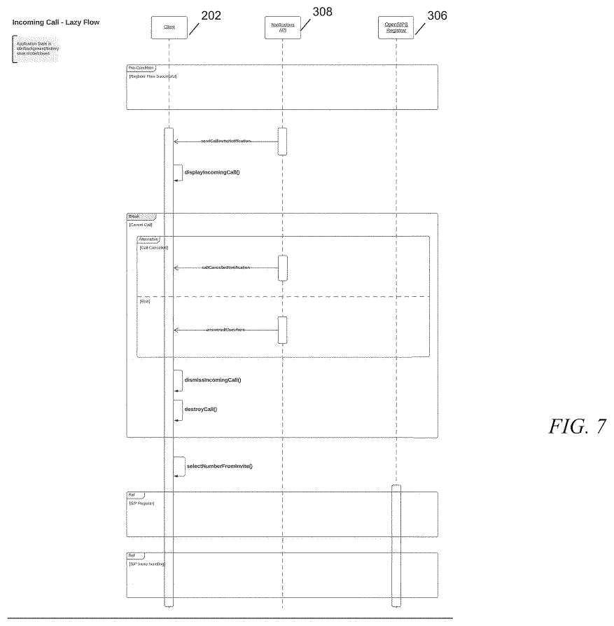

FIG. 7 illustrates an example notification-driven interaction flow for handling communication events within a client application 202 according to one or more embodiments. As shown, when an incoming communication event is detected by the SDK, the SDK determines an appropriate notification strategy based on the operational state of the client application. In some embodiments, the SDK triggers a system-level notification service when the application is running in a background or inactive state, thereby alerting a user of the incoming communication. The system-level notification may present actionable controls, such as options to accept or decline the communication request. User interaction with the notification generates an input event that is routed back to the client application and the SDK.

FIG. 7 illustrates an example incoming call handling flow when a client application is not active, referred to as a lazy flow, involving a Client, a NotificationsAPI, and an OpenSIPS Registrar, according to one or more embodiments. As shown, an incoming call is directed to the Client while the Client application is inactive, suspended, or otherwise not reachable through an active signaling connection. The OpenSIPS Registrar receives signaling associated with the incoming call and determines that the Client is registered but not currently active. In response to determining that the Client is inactive, the OpenSIPS Registrar invokes the NotificationsAPI to initiate delivery of an incoming call notification associated with the Client. The NotificationsAPI generates a notification event and delivers the notification to the Client through a notification delivery mechanism. Upon receipt of the notification, the Client application is launched, resumed, or otherwise activated. After becoming active, the Client establishes communication with the OpenSIPS Registrar to retrieve information associated with the incoming call.

FIG. 7 further illustrates that, once the Client is active, the Client may respond to the incoming call by transmitting a call response to the OpenSIPS Registrar. If the call is accepted, the Client sends an acceptance message and the OpenSIPS Registrar updates call state accordingly. If the call is declined or times out, the OpenSIPS Registrar updates call state to reflect termination.

Throughout the lazy flow, the OpenSIPS Registrar maintains call signaling and registration state, while the NotificationsAPI is used to re-engage the Client only when necessary, thereby deferring direct signaling until the Client becomes active.

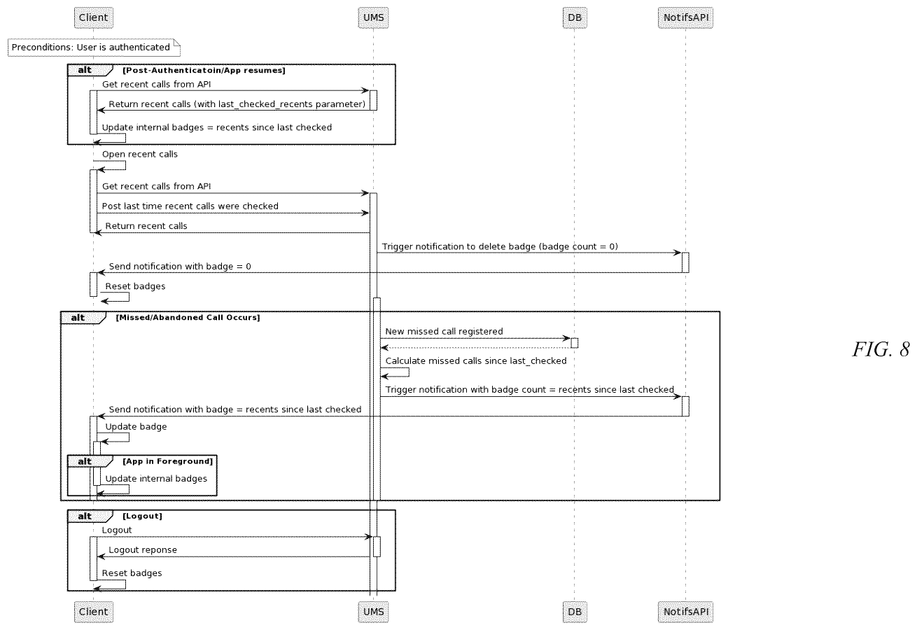

The second function implemented by the SDK is badges for missed and abandoned calls. FIG. 8 is a process flow diagram showing interactions between the Client applications, User Management System (UMS), database (DB), and Notifications API (NotifsAPI) to handle notifications of missed and abandoned calls, including mechanisms for updating and resetting the notification badge (visual indicator) count, ensuring users are promptly informed about call activity, according to the teachings of the present disclosure. In the context of SIP, a User Management System (UMS) refers to a system or component responsible for managing user accounts, profiles, and related information within a SIP-based communication network. The UMS plays a role in providing the necessary authentication and authorization mechanisms to allow users to access their call history. When a user wants to check their recent calls, they would first need to authenticate themselves to the SIP system. This authentication could involve providing a username and password, using a security token, or employing some other form of authentication mechanism. Once authenticated, the SIP system would then consult the UMS to determine whether the user has the necessary permissions to access their recent call history. The UMS would verify the user's credentials and check their access rights based on their user profile or role within the system. Assuming the user is authenticated and authorized, the SIP system would then query the appropriate data store or database to retrieve the user's recent call history. This could include details such as the date, time, duration, and parties involved in each call. After fetching recent calls and updating the last checked time, the UMS instructs the Notifications API (NotifsAPI) to trigger a badge reset notification, setting the badge count to 0, indicating that there are no new missed calls since the last check. The retrieved call history information would be presented to the user through their SIP client interface, which could be a desktop or mobile application, a web portal, or another user interface. The user would be able to view and interact with their recent calls as desired.

When the VoIP app resumes from a suspended state, the client requests the latest recent calls from the UMS. Upon receiving the latest recent calls, the client updates any internal badges or notifications to reflect the new state, ensuring that the user is promptly informed of any missed or abandoned calls.

In the event of a missed or abandoned call, the UMS records this in the database and calculates the number of missed calls since the user's last checked timestamp. The UMS then communicates with the NotifsAPI to send a notification to the client, including an updated badge count that reflects the recent missed calls.

If the app is in the foreground, it updates internal badges upon receiving notifications or through periodic checks, ensuring that the data accessible to the user is consistently accurate.

After the user successfully logs out of the application, the client resets any displayed badges, effectively clearing notifications related to missed or abandoned calls as part of the logout process.

Firebase Cloud Messaging (FCM) for Flutter is a plugin that enables developers to integrate Firebase Cloud Messaging functionality into their applications that have user interfaces built using Flutter, an open-source UI toolkit developed by Google for building natively compiled applications for mobile, web, and desktop from a single codebase. The FCM for Flutter plugin provides a Flutter-friendly interface for sending and receiving push notifications, data messages, and handling other messaging-related tasks. FCM is a cross-platform messaging solution provided by Google, designed to reliably deliver messages and notifications to mobile and web applications. It enables developers to send notifications, data messages, and upstream messages (messages from the client to the server) to their users on Android, iOS, and web platforms. FCM is used to handle various scenarios, including receiving notifications while the app is offline.

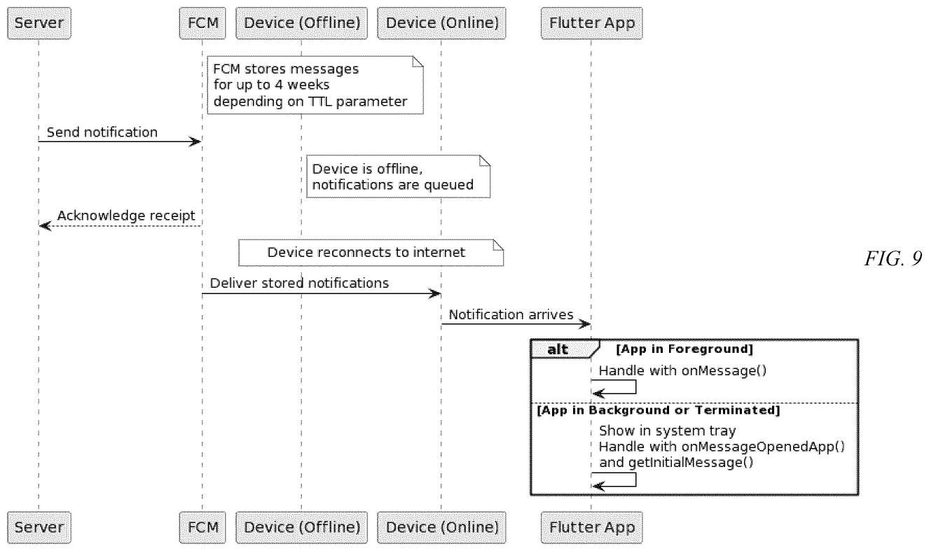

FIG. 9 illustrates an example notification handling flow across device connectivity states, involving a Server, FMC, a Device (Offline), a Device (Online), and a Flutter App, according to one or more embodiments. When the server sends a notification to a device via FCM, and the device is offline, FCM stores the message for a limited time period, such as up to four weeks. FCM attempts to deliver the messages as soon as the device goes online. The time FCM retains the message depends on the message's time-to-live (TTL) parameter that can be set by the sending user. While the device is in the offline state, it cannot receive push notifications. However, these notifications are queued in FCM's servers, waiting for the device to come back online by reconnecting to the internet.

Once the device reconnects to the internet and becomes online, FCM attempts to deliver all of the stored notifications to the device. In Flutter, when the application is back online and receives notifications, how these are handled depends on whether the app is in the foreground or background. If the app is in the foreground, incoming notifications are processed directly using the FirebaseMessaging. onMessage listener. If the app is in the background or terminated, FCM delivers the notifications to the system tray. Users can tap the notification to launch the app. You can handle the notification data using the FirebaseMessaging. onMessageOpenedApp and FirebaseMessaging. getInitialMessage( ) methods for background and terminated states, respectively. FIG. 9 further illustrates that the notification delivery mechanism supports seamless handling of device connectivity transitions, ensuring that notifications generated by the Server are delivered to the Flutter App when the device becomes available.

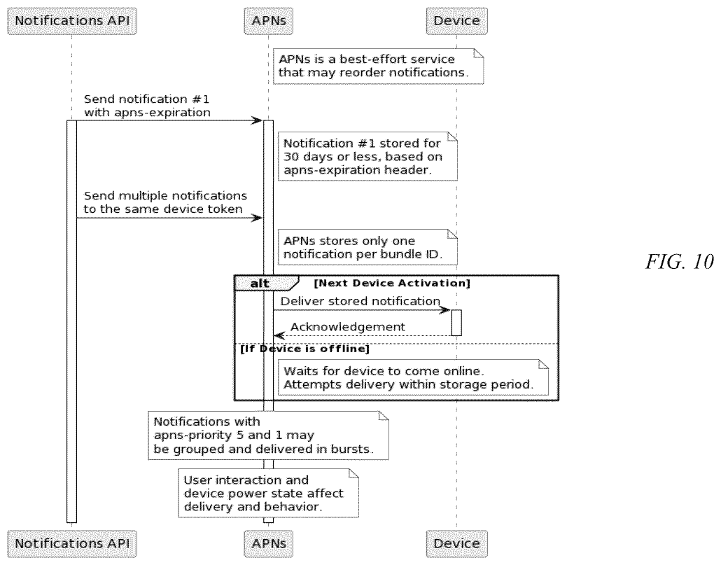

FIG. 10 is a process flow diagram of handling Apple Push Notification Service (APNs) according to the teachings of the present disclosure. Apple Push Notification Service (APNs) is a service provided by Apple that enables developers to send push notifications to iOS, iPadOS, watchOS, and macOS devices. Developers can use APNs to deliver notifications to users even when the corresponding app is not actively running on the device. These notifications can include text, badges, sounds, or custom data, and they can be targeted to specific users or devices based on various criteria. The server sends a notification to APNs, specifying the apns-expiration header to control how long APNs attempts to store the notification if it can't be delivered immediately. The “apns-expiration” header specifies a time value in seconds. If the notification cannot be delivered to the user's device immediately, APNs will attempt to store the notification and deliver it later. APNs may store the notification for up to 30 days, depending on the expiration header. However, for the same device token and bundle ID, APNs keeps only one notification, selecting which one to store in a non-deterministic manner. When the server sends multiple notifications to the same device for a bundle ID, APNs decides to store only one of those notifications. APNs attempts to deliver the stored notification the next time the device activates and connects online. If the device remains offline, APNs waits until the device comes back online within the notification's storage period to attempt delivery. Notifications with different priorities might be grouped and delivered in bursts, depending on the device's interaction with your application and its power state.

### Online Mode

```
@startuml
participant Client
participant UMS
participant DB
participant NotifsAPI
note over Client: Preconditions: User is authenticated
alt Post-Authenticatoin/App resumes
  Client -> UMS : Get recent calls from API
  activate Client
  activate UMS
  UMS -> Client : Return recent calls (with last_checked_recents parameter)
  deactivate UMS
  Client -> Client : Update internal badges = recents since last checked
  deactivate Client
end
Client -> Client : Open recent calls
activate Client
Client -> UMS : Get recent calls from API
activate UMS
Client -> UMS : Post last time recent calls were checked
UMS -> Client : Return recent calls
deactivate Client
UMS -> NotifsAPI : Trigger notification to delete badge (badge count = 0)
activate NotifsAPI
NotifsAPI -> Client : Send notification with badge = 0
deactivate NotifsAPI
activate Client
Client -> Client : Reset badges
deactivate Client
alt Missed/Abandoned Call Occurs
  activate UMS
  UMS -> DB : New missed call registered
  activate DB
  DB --> UMS
  deactivate DB
  UMS -> UMS : Calculate missed calls since last_checked
  UMS -> NotifsAPI : Trigger notification with badge count = recents since
last checked
  activate NotifsAPI
  NotifsAPI -> Client : Send notification with badge = recents since last
checked
  deactivate NotifsAPI
  activate Client
  Client -> Client : Update badge
  alt App in Foreground
    activate Client
    Client -> Client : Update internal badges
    deactivate Client
  end
  deactivate Client
  deactivate UMS
end
alt Logout
  Client -> UMS : Logout
  activate Client
  activate UMS
  UMS -> Client : Logout reponse
  deactivate UMS
  Client -> Client : Reset badges
  deactivate Client
end
@enduml
```

```
FCM
@startuml
participant Server
participant FCM
participant “Device (Offline)” as DeviceOffline
participant “Device (Online)” as DeviceOnline
participant “Flutter App” as FlutterApp
note right of FCM: FCM stores messages\nfor up to 4 weeks\ndepending on TTL
parameter
Server -> FCM : Send notification
note right of DeviceOffline: Device is offline, \nnotifications are queued
FCM --> Server : Acknowledge receipt
note over DeviceOffline, DeviceOnline: Device reconnects to internet
FCM -> DeviceOnline : Deliver stored notifications
DeviceOnline -> FlutterApp : Notification arrives
alt App in Foreground
FlutterApp -> FlutterApp : Handle with onMessage( )
else App in Background or Terminated
FlutterApp -> FlutterApp : Show in system tray\nHandle with
onMessageOpenedApp( ) \nand getInitialMessage( )
end
@enduml
APNS
@startuml
participant “Notifications API” as Server
participant “APNs” as APNs
participant “Device” as Device
note right of APNs: APNs is a best-effort service\nthat may reorder
notifications.
Server -> APNs : Send notification #1\nwith apns-expiration
activate Server
activate APNs
note right of APNs: Notification #1 stored for\n30 days or less, based
on\napns-expiration header.
Server -> APNs : Send multiple notifications\nto the same device token
note right of APNs: APNs stores only one\nnotification per bundle ID.
alt Next Device Activation
  APNs -> Device : Deliver stored notification
  activate Device
  Device --> APNs : Acknowledgement
  deactivate Device
else If Device is offline
  note right of APNs: Waits for device to come online. \nAttempts delivery
within storage period.
end
  note over APNs: Notifications with\napns-priority 5 and 1 may\nbe grouped and
delivered in bursts.
note over APNs: User interaction and\ndevice power state affect\ndelivery and
behavior.
deactivate APNs
deactivate Server
@enduml
```

The call stats module is another function implemented using the VoIP SDK. It is designed to gather, process, and publish statistical data from network and WebRTC sources during voice and video calls. This module is able to log, on a real-time basis, and store collected network and WebRTC statistical data for record keeping, debugging, and analysis purposes. The module provides a user/admin interface to enable access, view, and analysis of the collected data, and also manages authorized access by external entities or platforms. An important feature of the module is its polling mechanism, which collects statistical data at regular intervals, such as once per second. This polling function ensures a comprehensive statistical dataset for each call session.

Additional call stats module functionalities include real-time monitoring to continuously collect and display statistics for immediate observation, historical analysis of the data to examine the data retrospectively for trend analysis and historical reporting, performance optimization to identify and address network and communication efficiency and reliability issues, and diagnostic support to facilitate troubleshooting and problem-solving in network and WebRTC infrastructures.

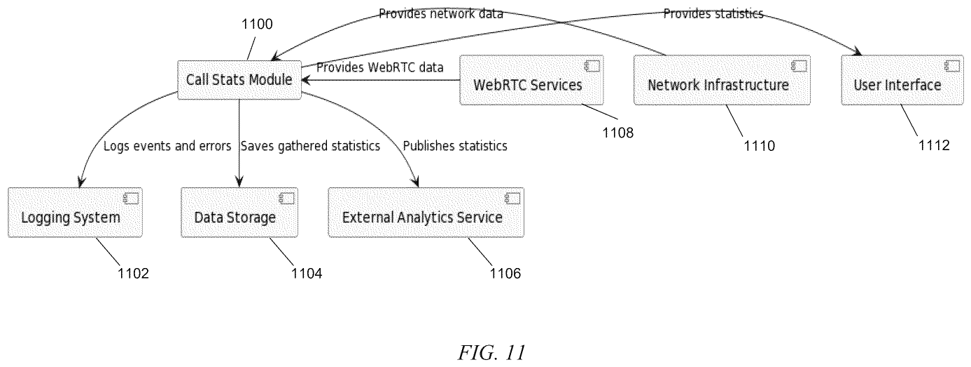

FIG. 11 is a system context diagram of the call stats module 1100 and its interactions with other system components and external entities. The call stats module logs operational and diagnostic events and errors in a logging system 1102, saves collected statistical data in a data storage 1104, and publishes the statistical data using an external analytics service 1106. The external analytics service may process the received data to generate analytics outputs, reports, or insights related to call quality, system performance, or user experience. The call stats module collects call-related metrics, including media performance data, session duration data, and event timing information. The call stats module receives media-related WebRTC data from WebRTC Services 1108, which manage real-time audio and video communication during a call. The call stats module also receives network data from the network infrastructure 1110. The user may access the statistics data presented by the user interface 1112 in a manner perceivable by the user.

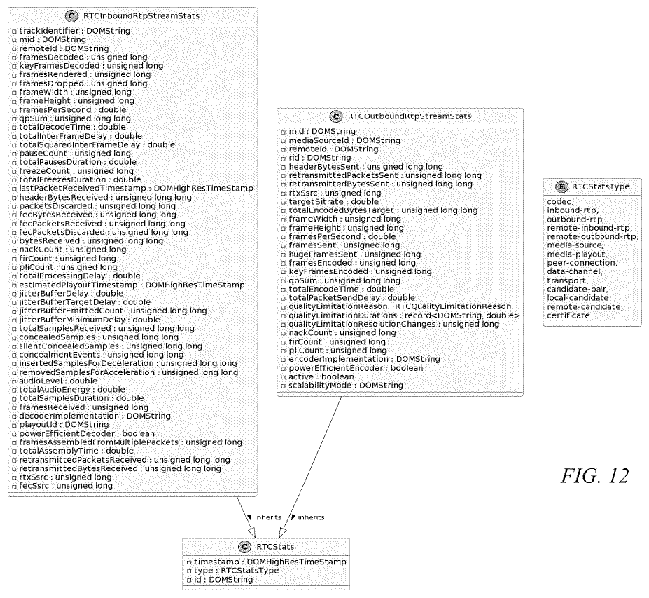

FIG. 12 is a diagram showing the statistics data being collected from a WebRTC session according to the teachings of the present disclosure. FIG. 12 shows the Call Stats Module designed to collect, log, and report statistics from both Network and WebRTC modules during an active call. The user or VoIP app starts a call, which triggers the call stats module to begin data collection. Data collection stops when the call ends. Various types of data can be gathered from a WebRTC session, each corresponding to a specific RTCStatsType value. These statistics provide detailed insights into various aspects of the WebRTC communication session, from the codecs used to the specifics of the ICE candidates and transport layers. This information is useful to diagnose and optimize WebRTC applications. The collected data include:
codec: Statistics for codecs used by RTP streams in the RTCPeerConnection, accessible via RTCCodecStats.
inbound-rtp: Statistics for inbound RTP streams received by the RTCPeerConnection, accessible via RTCInboundRtpStreamStats. RTX and FEC streams modify certain counters within these stats but are not represented as separate objects.
outbound-rtp: Statistics for outbound RTP streams sent by the RTCPeerConnection, accessible via RTCOutboundRtpStreamStats. Each RTP stream, such as those from simulcast, has its own stats object. RTX streams affect specific counters but are not separate stats objects.
remote-inbound-rtp: Statistics for the remote endpoint's inbound RTP stream, reported in RTCP Receiver Reports or Extended Reports, accessible via RTCRemoteInboundRtpStreamStats.
remote-outbound-rtp: Statistics for the remote endpoint's outbound RTP stream, reported in RTCP Sender Reports, accessible via RTCRemoteOutboundRtpStreamStats.
media-source: Statistics for media produced by a MediaStreamTrack attached to an RTCRtpSender, reflecting media post-constraints, accessible as either RTCAudioSourceStats or RTCVideoSourceStats.
media-playout: Statistics related to audio playout, accessible via RTCAudioPlayoutStats.
peer-connection: Statistics related to the RTCPeerConnection object itself, accessible via RTCPeerConnectionStats.
data-channel: Statistics for each RTCDataChannel, accessible via RTCDataChannelStats.
transport: Transport statistics related to the RTCPeerConnection, accessible via RTCTransportStats.
candidate-pair: ICE candidate pair statistics related to RTCIceTransport objects, accessible via RTCIceCandidatePairStats. These stats are deleted based on specific conditions related to ICE restarts.
local-candidate: Statistics for local ICE candidates, accessible via RTCIceCandidateStats for the local candidate, deleted under certain conditions after an ICE restart.
remote-candidate: Statistics for remote ICE candidates, accessible via RTCIceCandidateStats for the remote candidate, also deleted under certain conditions after an ICE restart.
certificate: Information about certificates used by an RTCIceTransport, accessible via RTCCertificateStats.

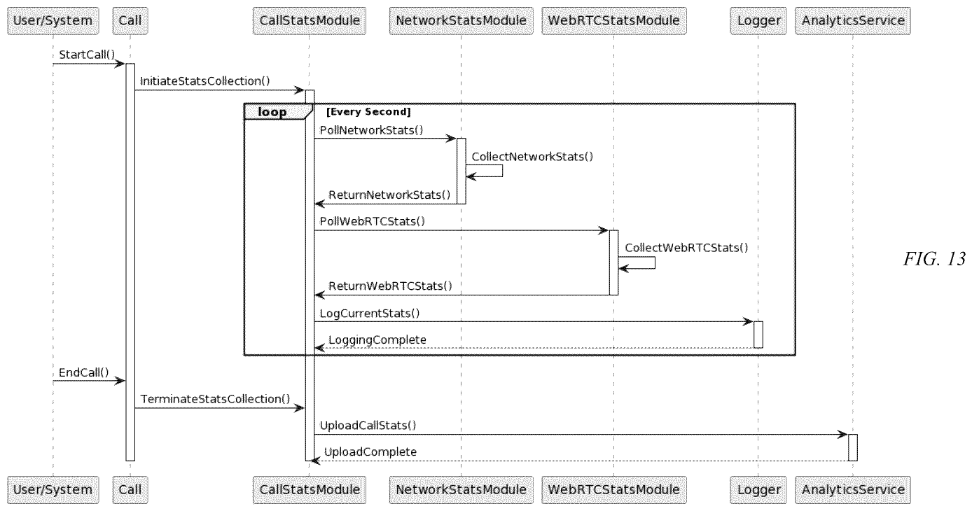

FIG. 13 is a message flow diagram of the call stats module processes. In FIG. 13, the User/System represents the end-user or system triggering call actions, NetworkStatsModule is a module dedicated to collecting network-related statistics, WebRTCStatsModule is a module dedicated to collecting statistics specific to WebRTC, the Logger is the logging service that captures real-time data for auditing and troubleshooting, and Analytics Service is an external service for aggregating, analyzing, and storing call statistics. Referring to FIG. 13:
StartCall: The call stats collection process is triggered when a user initiates a call.
InitiateStatsCollection: The call stats module begins its operation by signaling the commencement of the statistics collection.
PollNetworkStats and PollWebRTCStats: The call stats module polls the NetworkStatsModule and WebRTCStatsModule at regular intervals, approximately once every second.
CollectNetworkStats: The module sends a request to the NetworkStatsModule to collect current network statistics. Upon receiving the network data, the call stats module stores this information internally for cumulative statistics.

CollectWebRTCStats is sent to the WebRTCStatsModule for WebRTC-specific data. This data, once received, is also stored internally alongside the network stats.
LogCurrentStats and LoggingComplete: After each polling cycle, the call stats module sends the newly gathered statistics to the logger for real-time logging. This ensures that all data points are recorded continuously throughout the call.
EndCall: When the call is concluded, typically indicated by the user, the call stats module receives TerminateStatsCollection to terminate the stats collection.
UploadCallStats and UploadComplete: Post call, the module compiles the gathered statistics and initiates an upload process to an external Analytics Service. This service is responsible for processing and storing call-related data for further analysis.

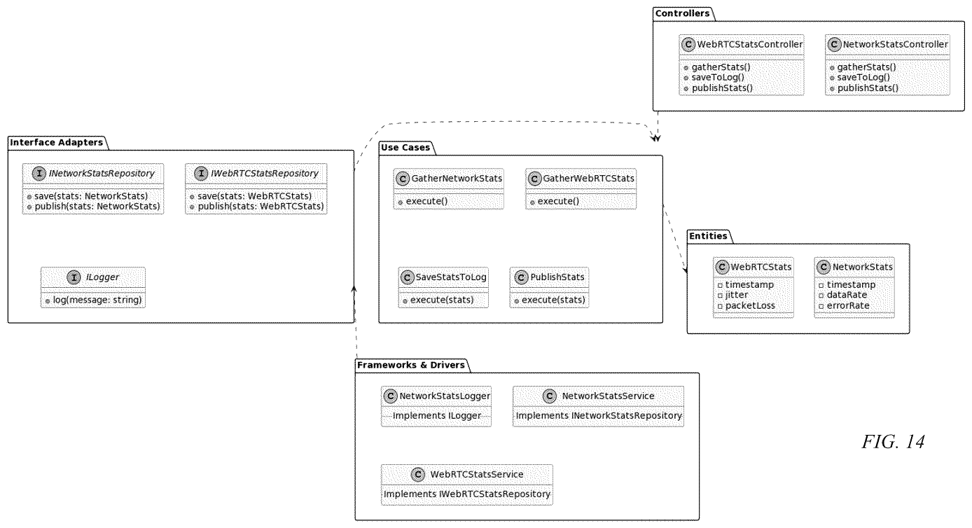

FIG. 14 is an architecture diagram of the Call Stats Module according to the teachings of the present disclosure. The call stats module further includes an interface adapters architecture layer that convert data between the format(s) most convenient for use cases, entities, and external agencies and frameworks. The use cases for Call Stats Module include:
GatherNetworkStats: Handles the logic for collecting network statistics.
GatherWebRTCStats: Manages the collection of WebRTC statistics.
SaveStatsToLog: Saves the gathered statistics to logs.
PublishStats: Handles the publishing of statistics to a designated service.

The NetworkStatsService integrates network statistics collection frameworks, and WebRTCStatsService Incorporates WebRTC data collection tools.

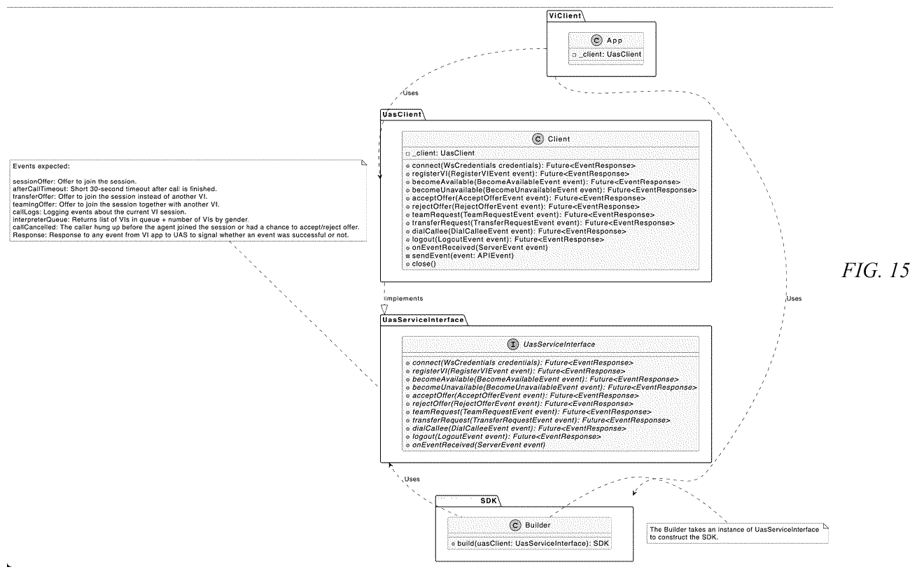

FIG. 15 shows a diagram that illustrates the API contract between User Agent Server (UAS) and Video Interpreter (VI) App. The SDK 100 further implements the API contract between UAS and the Video Interpreter (VI) app, which uses a WebSocket for real-time communication. The VI client is the client-side application used by Video Interpreters in Video Relay Service (VRS). It consumes a UAS client, which implements the contract for communication over WebSockets between the VI client and the UAS. The VI client handles real-time operations like accepting/rejecting session offers, registering VI stats, changing the availability status, handling team or transfer requests, and dialing a callee. The UAS service interface defines a set of operations and events which are implemented for interaction between the UAS and the VI client. This includes method definitions for connecting, sending events, and closing the WebSocket. This interface is meant to be implemented by any client intended to communicate with the UAS, ensuring a consistent API for this communication. The UAS client is an instance of the UAS Service Interface implementation. It serves as a concrete embodiment of the UAS Service Interface, providing the specific implementation details of the WebSocket communication methods defined in the UAS Service Interface. This instance is what's actually used to establish communication between the VI Client and the UAS. The SDK 100 uses SIP to establish sessions with a SIP server and WebRTC for peer-to-peer communication between different Client implementations of the SDK. When the SDK 100 is being built, it requires an instance of the UAS Service Interface as a parameter in its builder function. In this case, it will consume the UAS Client instance. The SDK 100 uses this instance to perform WebSocket communications, delegating the low-level details to the UAS Client while providing a higher-level, simplified API for application developers to establish SIP connections and WebRTC calls.

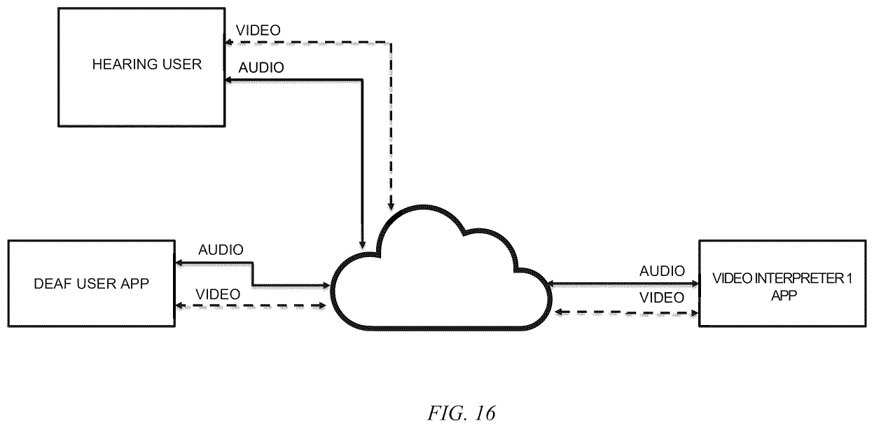

FIG. 16 is a simplified block diagram of an exemplary embodiment of the VRS system architecture according to the teachings of the present disclosure. VRS allows deaf people to communicate with hearing individuals through a videoconferencing platform. A video sign language interpreter or VI relays the conversation between the two parties. During a VRS session, the deaf user, hearing user, and video interpreter are in a three-way video conferencing session where all three parties receive audio and video information of one other. The video interpreter facilitates communication between the deaf user and the hearing user by interpreting spoken language into sign language and vice versa.

### GLOSSARY

ACK Acknowledgement
API Application Programming Interface
APNs Apple Push Notification Service
CPaaS Communications Platform as a Service
FCM Firebase Cloud Messaging
HTTP Hypertext Transfer Protocol
ICE Interactive Connectivity Establishment
IP Internet Protocol
NVP Network Voice Protocol
QoS Quality of Service
REST Representational State Transfer
RTC Real-Time Communication
RTP Real-Time Transport Protocol
SDK Software Development Kit
SIP Session Initiation Protocol
TTL time-to-live
UAS User Agent Server (responsible for receiving and processing SIP requests)
UC User Agent Client (responsible for initiating SIP requests)
UI User Interface
UMS User Management System
VI Video Interpreter
VoIP Voice over IP
VRI Video Remote Interpreting
VRS Video Relay Service
WebRTC Web Real-Time Communication
WS WebSocket

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

What is claimed is:

1. A software development kit (SDK) configured to be integrated with a client application executing on a user device, the SDK comprising:
an application programming interface (API) layer configured to receive requests for communication services from the client application;
a registrar configured to manage registration state associated with the client application;
an orchestrator configured to coordinate communication operations within the SDK;
a signaling module configured to manage session initiation, termination, and call state signaling for audio and video communication sessions;
a media module configured to manage real-time media streams; and
a communication provider adapter interface defining a standardized interface for accessing communication services;
at least one communication provider adapter coupled to the communication provider adapter interface, the communication provider adapter being configured to translate SDK-level communication requests into provider-specific operations; and
wherein the communication provider adapter is configured to enable communicative coupling between the client application with at least one external communication service platform, such that the client application is able to access communication services through the API layer without direct dependency on provider-specific signaling and media protocols.

2. The SDK of claim 1, further comprising a video interpreter module configured to handle signaling requests with a video interpreter user agent server.

3. The SDK of claim 1, further comprising an error handler configured to manage and handle errors associated with the communication services within the SDK.

4. The SDK of claim 1, further comprising a network state observer configured to monitor network state associated with the communication services.

5. The SDK of claim 1, further comprising a logs manager configured to log data and stats within the SDK.

6. The SDK of claim 1, further comprising a negotiator configured to manage a negotiation process for establishing a communication session between the client application and the at least one external communication service platform.

7. The SDK of claim 1, further comprising a native platform interface configured to facilitate interaction between the SDK and the user device.

8. The SDK of claim 1, further comprising an incoming call handler configured to manage and process an incoming call to the client application.

9. The SDK of claim 1, wherein the communication provider adapter interface supports a plurality of provider adapters corresponding to different external communication service platforms.

10. The SDK of claim 1, wherein the SDK is configured to switch between the at least one communication provider adapter to another communication provider adapter without modification to the client application.

11. A method for accessing communication services through an adapter-based software development kit (SDK), comprising:
receiving, at the SDK, a communication request from a client application;
forwarding the communication request from the SDK to a communication provider adapter interface that defines a standardized interface independent of a specific communication service provider;
delegating the communication request from the communication provider adapter interface to a selected communication provider adapter that implements provider-specific logic;
transmitting, by the selected communication provider adapter, a provider-specific request to an external communication service platform to access a communication service;
receiving, from the external communication service platform, a response associated with the communication service; and
propagating the response from the selected communication provider adapter through the communication provider adapter interface and the SDK to the client application, wherein the client application is able to access the communication service without direct dependency on provider-specific application programming interfaces or protocols of the external communication service platform.

12. The method of claim 11, further comprising detecting an error condition associated with the external communication service platform.

13. The method of claim 11, wherein receiving the communication request comprises receiving a request to at least one of initiate, modify, and terminate a communication session.

14. The method of claim 11, further comprising collecting performance metrics associated with the communication service.

15. The method of claim 11, further comprising:
supporting and registering at least one user telephone number associated with a user Video Relay Service (VRS) account for incoming and outgoing calls;
maintaining and updating internal badges to reflect a current status of the user VRS account, including missed calls and abandoned calls;
collecting and recording call status data for each incoming and outgoing call associated with the user VRS account, selected from the group consisting of network data, codec statistics, inbound-Real-Time Transport Protocol (RTP) data, outbound-RTP data, remote inbound-RTP data, remote outbound-RTP data, media statistics, audio playout statistics, data channel statistics, transport statistics, Interactive Connectivity Establishment (ICE) candidate pair statistics, local ICE candidate statistics, remote ICE candidate statistics, and Real-Time Communication (RTC) certificate statistics; and
supporting real-time communications using a WebSocket connection between a User Agent Server (UAS) and a Video Interpreter (VI) client application.

16. A communication system comprising:
software development kit (SDK) configured to receive a communication request from a client application;
a communication provider adapter interface coupled to the SDK;
at least one communication provider adapter communicatively coupled to the communication provider adapter interface and configured to translate the communication request into a provider-specific request; and
an external communication service platform communicatively coupled to the at least one communication provider adapter, wherein the SDK provides access to the external communication service platform without exposing provider-specific interfaces to the client application.

17. The communication system of claim 16, wherein the SDK further comprises:
an application programming interface (API) layer configured to receive the request for communication service from the client application;
a registrar configured to manage registration state associated with the client application;
an orchestrator configured to coordinate communication operations within the SDK;
a signaling module configured to manage session initiation, termination, and call state signaling for audio and video communication sessions; and
a media module configured to manage real-time media streams.

18. The communication system of claim 17, wherein the at least one communication provider adapter is configured to enable communicative coupling between the client application with the external communication service platform, such that the client application is able to access communication services through the API layer without direct dependency on provider-specific signaling and media protocols.
